(19) United States
(12) Patent Application Publication
(10) Pub. No.: US 2002/0040333 A1
(43) Pub. Date: Apr. 4, 2002

(54) System for selling unique information indicating products over transmission network

(75) Inventor: Tetsuji Fuwa, Hashima-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Aichi-ken (JP)

(21) Appl. No.: 09/963,489

(22) Filed: Sep. 27, 2001

(30) Foreign Application Priority Data
Oct. 4, 2000 (JP) P2000-304370
Oct. 4, 2000 (JP) P2000-304369

(51) Int. Cl. G06F 17/60

(52) U.S. Cl. 705/27

(57) ABSTRACT

A customer computer sends a customer ID to a server that sells, over a transmission network such as the Internet, stamps, business cards, or other products that indicate unique information. Based on the received customer ID, the server extracts customer information from a customer database. A preview image preparation portion of the server uses the extracted information to prepare a preview image of a stamp that the customer ordered in the past. The server transmits the preview image to the customer computer, which displays the preview image using a browser.

### BACKGROUND OF THE INVENTION

1. Field of the Invention

The present invention relates to a system for selling unique information indicating products over a transmission network.

2. Description of the Related Art

Recently, in association with developments in computer network technology, of which the Internet is a representative example, e-commerce transactions using graphic-user interfaces (GUI) over the world-wide web (WWW) are becoming extremely popular. Especially “mail-order” business between retail businesses and consumers is booming. By using the WWW for “mail order” transactions, potential customers benefit because they can view sample images of many products using the browser of their personal computer to confirm the nature of products before buying them. Not only can customers buy products quickly, but also with peace of mind. Businesses benefit because they can receive orders cheaply from a broad geographic range of customers.

### SUMMARY OF THE INVENTION

Some products are formed or are printed with unique information about an individual or a company. Examples of such products include ink stamps or business cards. Examples of the unique information formed or printed on these products include an individual's or company's name, address, post office number, telephone number, or email address. Individual products become more unique the more information is indicated on the product.

It is conceivable to sell such products over the Internet. However, in this case the customer would not be able to confirm what the actual product will look like before buying the product. That is, the only images available to the customer would be samples of products having a similar layout, but not the unique information desired by the customer for the actual product. The customer would not be able to get a good idea of what the actual product would look like. This would be very inconvenient to the customer.

For example, the number of rows of characters may differ between the sample image and the actual product delivered to the customer. That is, if the customer purchases a product with a great many more characters than shown in the sample image displayed using the computer's browser, then characters that the customer intended to be aligned in a single row, as indicated in the sample image, may be divided into two or more rows in the actual product. As a result, the actual product delivered to the customer would greatly differ from the customer's expectations. For this reason, customers would feel insecure when making a purchase of stamps, business cards, and the like over the Internet. This is a great obstacle in attempts to sell, over the Internet, stamps, business cards, and other products that indicate unique information.

It is an objective of the present invention to provide a method, system, and server for selling unique information indicating products, such as a stamp or business cards, that enables a user to confirm what an actual unique information indicating product will look like before purchasing it, so that the customer can order such products over the Internet of other transmission network without worry.

In order to achieve the above-described objectives, a method according to a first aspect of the present invention is for selling, over a transmission network, unique information indicating products that indicate unique information. The method includes receiving, at a server, unique information supplied from a client device across the transmission network to the server; preparing, based on unique information, a preview image of a unique information indicating product that indicates the unique information; transmitting the prepared preview image to the client device; and displaying the preview image using a browser of the client device.

A system according to the first aspect of the present invention is for selling unique information indicating products that indicate unique information. The system includes a client device and a server connected via a transmission network, wherein: the client device supplies unique information to the server across the transmission network; the server receives the unique information supplied from the client device, prepares, based on the unique information supplied from the client device, a preview image of a unique information indicating product that indicates the unique information, and transmits the prepared preview image to the client device; and the client device includes a browser that displays the preview image from the server.

A server according to the first aspect of the present invention is for selling, over a transmission network, unique information indicating products that indicate unique information. The server includes a preview image preparation unit that prepares, based on unique information supplied over the transmission network from a client device, a preview image of a unique information indicating product that indicates the unique information; and a transmission unit that transmits the prepared preview image to the client device.

The method, system, and server according to the first aspect of the present invention enables a purchaser of unique information indicating products to decide to purchase a unique information indicating product after viewing the preview image displayed by operation of the browser. Therefore, products that do not match the purchaser's imagined understanding of the product will not be produced. This greatly improves the convenience of making purchases using the Internet.

It is desirable that in the method, system, and server according to the first aspect of the present invention, the preview image be prepared in real time in response to character input performed at the client device for the unique information. With this configuration, the preview images are displayed using the browser in real time. Therefore the purchaser can automatically confirm each small change in the preview images in accordance with character input by the purchaser.

It is desirable that in the method, system, and server according to the first aspect of the present invention, the preview image be prepared in response to a preview reception request sent from the client device to the server. With this configuration, preview images are prepared and displayed in response to a preview reception request from the client. therefore, the server transmits data for displaying the preview image only once after the unique information has been completely input. Even if the server and the client are connected by a connection with a slow transmission speed, not much time is required for transmitting data from the server to the client.

It is desirable that in the method according to the first aspect of the present invention, the browser of the client device is used to display a plurality of preview images corresponding to different colors, text fonts, and/or sizes selectable for the unique information indicating product. With this configuration, a plurality of unique information indicating products can be displayed in different colors, fonts, or sizes. Therefore the purchaser can more reliably confirm the unique information indicating product before purchasing it

It is desirable that in the method according to the first aspect of the present invention, the browser of the client device is used to display a plurality of preview-images corresponding to different types selectable for the unique information indicating product.

With this configuration, a plurality of different one of the selectable unique information indicating products can be displayed. Therefore, this urges the purchaser to purchase different types of unique information indicating products, thereby promoting sales of the unique information indicating products

It is desirable that in the method according to the first aspect of the present invention, the step of receiving the unique information includes receiving a customer identifier; the step of preparing the preview image includes extracting, from a customer database that stores customer identifiers in correspondence with customer information, unique information associated with the customer identifier and preparing the preview image to indicate the extracted unique information on the unique information indicating product; and the step of displaying includes displaying the extracted unique information in the preview image of the unique information display product. In this case, it is further desirable that the step of preparing includes preparing a customer identifier when the server receives unique information to be displayed on the unique information indicating product, but does not receive a customer identifier; and the step of transmitting the prepared preview image to the client device includes transmitting the prepared customer identifier.

It is desirable that in the system according to the first aspect of the present invention, the client device supplies a customer identifier with the unique information to the server across the transmission network; the server extracts unique information associated with the customer identifier from a database that stores customer identifiers in correspondence with customer information; and the server prepares and transmits the preview image of the unique information indicating product indicating the unique information extracted from the customer database. In this case, it is further desirable that when the server receives, from the client device, unique information to be indicated on the unique information indicating product, but does not receive a customer identifier, the server prepares a customer identifier and a preview image of the unique information product indicating the unique information and transmits the preview image and the customer identifier to the client device.

It is desirable that the server according to the first aspect of the present invention further include a memory storing a customer database with customer identifiers in correspondence with customer information; and a unique information extracting unit that extracts, from the customer database, unique information to be indicated on the unique information indicating product, based on a customer identifier supplied from a client device over the transmission network, the preview image preparation unit preparing the preview image of the unique information indicating product to indicate the unique information extracted from the customer database. In this case, it is further desirable that the server further include a customer identification preparation unit that prepares a customer identifier when unique information indicated on the unique information indicating product is supplied over the transmission network but a customer identifier is not supplied, the preview image preparation unit prepares the preview image of the unique information indicating product to indicate unique information when unique information to be indicated on the unique information indicating product is supplied over the transmission network from a client device, the transmission unit transmitting the preview image and the customer identifier to the client device.

With the method, system, and server configured in this manner, when a customer identifier is input, a preview image of a unique information indicating product that indicates unique information is displayed by operation of the browser. This reduces the number of characters that the customer needs to input when purchasing a unique information indicating product and reduces the labor of the customer. With the method, system, and server with the configuration described above as further desirable, a customer identifier can be issued and notified to customers. This makes it easier for the customer to make a purchase the next time.

A method according to a second aspect of the present invention includes transmitting a customer identifier from a client device over the transmission network to a server; receiving the customer identifier at the server; extracting, from a customer database that stores customer identifiers in correspondence with customer information, past order information associated with the customer identifier; preparing, based on the past order information extracted from the database, a review image of a unique information indicating product ordered in the past; transmitting the prepared review image to the client device; and displaying the review image using a browser of the client device.

A system according to the second aspect of the present invention includes a client device and a server connected via a transmission network, wherein: the client device supplies the customer identifier to the server across the transmission network; and the server receives the customer identifier supplied from the client device and extracts, from a customer database that stores customer identifiers in correspondence with customer information, information about past orders associated with the customer identifier; the server prepares, based on the information about past orders extracted from the database, a review image of a unique information indicating product ordered by a customer in the past; the server transmits the review image to the server; and the client device includes a browser that displays the review image.

A server according to the second aspect of the present invention includes a memory storing a customer database with customer identifiers in correspondence with customer information; an order information extracting unit that extracts, from the customer database, information about past orders associated a customer identifier supplied from a client device over the transmission network; a review image preparation unit that prepares a review image of a unique information indicating product based on the past order information extracted from the customer database; and a transmission unit transmitting the prepared review image to the client device.

The method, system, and server according to the second aspect of the present invention enables the client's browser to operate to display, based on information of a past order, a review image of a unique information indicating product that the customer ordered in the past. Therefore, the customer can determine content of a new product while referring to the layout of a product he or she has purchased in the past.

It is desirable that in the method, system, and server according to the second aspect of the present invention, at least one of a sample image of a unique information indicating product and a preview image of a unique information indicating product that indicates the unique information extracted from the customer database are transmitted to the client device along with the review image; and the at least one of the sample image and the preview image are displayed along with the review image.

With the method, system, and server with this configuration, the review image, sample image, and preview image of the unique information indicating product is displayed on the browser. Therefore, the customer can easily determine content of products before he or she makes a new purchase.

A method according to a third aspect of the present invention includes using at least one of order information for a unique information indicating product and unique information to be indicated on the unique information indicating product as corresponding information in another one of the at least one of the order information and the unique information.

A system according to the third aspect of the present invention includes a client device and a server connected via a transmission network, wherein: one of order information for a unique information indicating product and unique information to be indicated on the unique information indicating product is used as corresponding information in the other of the at least one of order information and unique information.

A server according to the third aspect of the present invention includes using means that uses one of order information for a unique information indicating product and unique information to be indicated on the unique information indicating product as corresponding information in the other of the at least one of order information and unique information.

The method, system, and server according to the third aspect of the present invention uses the unique information corresponding information in the order information about a unique information indicating product and the unique information to be indicated on a unique information indicating product interchangeably. Therefore, there is no need for the customer to input redundant information. There will be fewer mistakes when inputting data, because less input is required.

It is desirable that in the method, system, and server according to the third aspect of the present invention, a portion of the corresponding information in the order information is used as corresponding information for another portion of at least one of the order information and the unique information. With this configuration, a portion of the unique information correspondence information in the order information about a unique information indicating product can be used as another portion. Therefore, the user does not need to input redundant information.

A method according to a fourth aspect of the present invention includes extracting, based on a customer identifier, unique information from a customer database that stores customer identifiers in correspondence with customer information; preparing a preview image of a unique information indicating product that indicates the extracted unique information; and transmitting the prepared preview image to an email address associated with the customer identifier

A system according to the fourth aspect of the present invention includes a client device and a server connected via a transmission network, wherein the server extracts, based on a customer identifier, unique information from a customer database that stores customer identifiers in correspondence with customer information, prepares a preview image of a unique information indicating product that indicates the extracted unique information, and transmits the prepared preview image to an email address associated with the customer identifier.

A server according to the fourth aspect of the present invention includes a memory storing a customer database with customer identifiers in correspondence with customer information; a preview image preparation unit that prepares a preview image of a unique information indicating product that indicates unique information extracted from the customer database; and a transmission unit that transmits the prepared preview image to an email address corresponding to one of the customer identifiers.

In the method, system, and server according to the fourth aspect of the present invention, the preview image of a newly designed unique information indicating product is sent to the email address of a customer stored in the customer database, thereby stimulating the customer desire to make a purchase and increasing demand of the unique information indicating products Also, the customer can make a purchase by merely returning the email message to the sender, which is very convenient to the customer.

According to the present invention, “unique information” includes a variety of information, such as names, addresses, telephone numbers, and email addresses of individuals or groups of individual, such as companies, and also creative text, catch phrases, or other combinations of symbols that have a particular meaning. According to the present invention, “unique information indicating products” include stamps, business cards, tags, labels, stickers, and any other product that indicates unique information in some way.

More than one preview image can be prepared. A variety of different types of preview images can be prepared as sample images.

According to the present invention, “customer information” includes at least one of a customer's personal information and order information. Customer's a “personal information” includes the customer's name, address, telephone number, and email address.“Order information” the addressee, number of products ordered, type of product ordered, unique information that is indicated by the product, and other information about past orders of unique information indicating products.

Also, “unique information extracted from the customer database” can be either personal information about the customer, information about the addressee, or unique information indicated on a product that was ordered in the past

According to the present invention, “transmission network” includes any well-known networks such as the Internet, LANs, or WANs. It should be noted that according to the present invention, the “server” can be a single computer that performs all functions, or a group of computers with functions divided therebetween.

Also, “character input” includes addition and erasure of alphanumeric characters, and also conversion of input Roman or Japanese kana characters into Chinese characters such as Japanese kanji.

### BRIEF DESCRIPTION OF THE DRAWINGS

The above and other objects, features and advantages of the invention will become more apparent from reading the following description of the embodiment taken in connection with the accompanying drawings in which:

FIG. 1 is block diagram showing a stamp sales system according to the embodiment;

FIG. 2 is a chart representing content of a customer database of the system;

FIG. 3 is a flowchart representing operations performed in a server of the system, including operations performed when the customer inputs a customer ID;

FIG. 4 is a flowchart representing operations performed in the server when the customer indicates a desire to order a product displayed in a review or preview image;

FIG. 5 is a flowchart representing operations performed in the server when no customer ID is input;

FIG. 6 is a schematic view showing an ID input screen displayed by operation of a browser at a client device of the system of FIG. 1;

FIG. 7 is a schematic view showing a stamp face information input screen displayed by operation of the browser at the client device;

FIG. 8 is a schematic view showing a preview image screen displayed by operation of the browser at the client device;

FIG. 9 is a schematic view showing an order confirmed screen displayed by operation of the browser at the client device;

FIG. 10 is a flowchart representing processes performed by the server for selling stamps according to a modification of the embodiment, wherein preview images are displayed in real time based on input from the client device;

FIG. 11 is schematic view showing a stamp face information input screen displayed by real time operation of the browser of the client device according to the modification of FIG. 10;

FIG. 12 is a flowchart representing processes performed by a server device according to another modification of the embodiment, wherein a plurality of preview images are displayed separately for each different ink color, each different font, and for each different stamp size;

FIG. 13 is a flowchart representing processes performed by a server device according to still another modification of the embodiment, wherein direct mail sales of stamps is performed; and

FIG. 14 is a schematic view showing a screen displayed by operation of a mailer in the client device according to the modification of FIG. 13.

### DETAILED DESCRIPTION OF THE EMBODIMENT

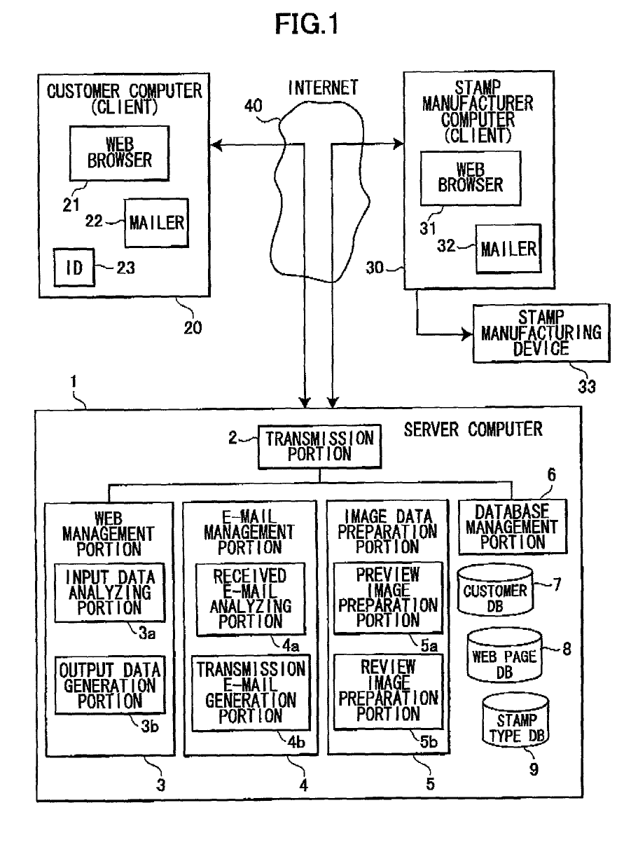

FIG. 1 is a block diagram showing a system according to an embodiment of the present invention. The system is for selling stamps and includes computers 1, 20, 30, all connected together by the Internet 40 so as to be capable of mutual transmission of data. The server computer 1 is a server that belongs to the seller of the stamps The computers 20 and 30 are client devices of the computer 1. The customer computer 20 belongs to a customer who wishes to buy a stamp. The manufacture computer 30 belongs to a stamp manufacturer. It should be noted that although FIG. 1 shows only two client devices 20, 30, all computers connected to the Internet are potential client devices in this embodiment.

The server computer 1 includes a transmission portion 92, a web management portion 3, a mail management portion 4, an image data preparation portion 5, a database management portion 6, a customer database 7, a web page database 8, and a stamp type database 9. The transmission portion 2 is for performing transmission and reception of data with the computers 20, 30 using protocol that conforms with the Internet.

The web management portion 3 is for managing transmission to and reception from a web page over the Internet using hyper text transfer protocol (HTTP). The web page is written in hyper text markup language (HTML). The web management portion 3 includes an input data analyzing portion 3a and an output data generation portion 3b. The input data analyzing portion 3a analyzes the content of data supplied, based on HTTP, over the Internet 40 through the transmission portion 2. The output data generation portion 3b generates NTML data in accordance with the analysis results of the input data analyzing portion 3a. The transmission portion 2 transmits the HTML data based on HTTP for supply to the computers 20, 30.

The mail management portion 4 is for managing transmission of email messages using a simple mail transfer protocol (SMTP) and reception of email messages using post office protocol (POP) The email messages are written as text data, HTML, or both. The mail management portion 4 includes a received email analyzing portion 4a and a transmission mail generation portion 4b. The received email analyzing portion 4a analyzes the content of email messages supplied, based on POP, over the Internet to the transmission portion 2 and the mail management portion 4. The transmission email generation portion 4b generates email messages that the transmission portion 2 supplies to the computers 20, 30 based on SMTP.

The image data preparation portion 5 includes a preview image preparation portion 5a and a review image preparation portion 5b. The preview image preparation portion 5a prepares unique sample images when a customer identification number (ID) is input. Each unique sample image is a preview image of a different stamp type indicating information, such as name, address, and the like, about the customer that corresponds to the input customer ID. The preview image preparation portion 5a prepares a preview image upon receiving a request from the customer computer 20. The preview image shows a stamp face of a stamp that the customer is considering to order. It should be noted that, as will be described later in a modification of the embodiment, the preview image preparation portion 5a can be modified to prepare preview images in real time in response to text input of stamp face content at the customer computer 20. The review image preparation portion 5b prepares a review image when a customer with a customer ID registered in the customer database 7 performs processes to place an order for a stamp. The review image shows a stamp face that was ordered by a customer in the past.

The database management portion 6 is for managing the three databases 7, 8, and 9. That is, the database management portion 6 extracts necessary data from the databases 7, 8, and 9 and also controls rewrite operations of the databases 7, 8, and 9. The database management portion 6 also prepares a customer ID for those customers who do not have a customer ID when placing an order, and writes the customer ID in the customer database 7.

The customer database 7 records information, such as a customer identification number (ID), about customers with a past purchasing history. As shown in FIG. 21 the customer database 7 stores information relating to customers in association with customer IDs, which serve as unique identifiers for each customer. The information relating to customers is divided into personal information and past order information. The personal information relates to the customer him or herself, such as name, address, email address, and telephone number of the customer The past order information includes the date each order was placed, type of stamp ordered, content of text rows on the ordered stamp face, ink color, font, number of stamps ordered, and addressee information.

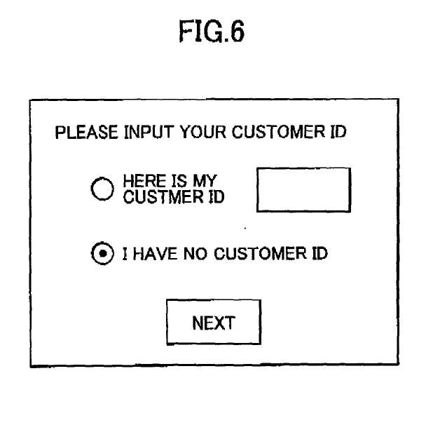

The web page database 8 records web page HTML files, including email files, that are for transmission to the computers 20, 30 The web page database 8 stores RTML files for the customer computer 20, HTML files and email files for the manufacturer manufacture computer 30, and email files for the customer computer 20. The server computer 1 transmits different HTML files to the customer computer 20 during different stages of the stamp ordering process, whereupon they are displayed by functioning of the browser of the customer computer 20 as shown in FIGS. 6 to 9. The server computer 1 transmits email files to the customer computer 20 when performing direct mail sales.

The stamp type database 9 stores files relating to layout of each type of stamp available from the seller. The stamp type database 9 stores the name of each stamp type in correspondence with the layout. Examples of stamp type names include A-02, A-03, and the like. The layout is the design of the stamp face and includes the size of the stamp face overall and the position of lines that divide character position regions in the stamp face. The stamp type database 9 also stores sample images for each stamp type. The sample images show how the stamp face ordinarily appears with a pre-prepared and fixed stamp face.

The customer computer 20 is installed with a browser 21, which is Web viewing software, and a mailer 2, which is email transmission and reception software. It should be noted that when a stamp is purchased from the server computer 1 through the customer computer 20, the server 1 sends an HTML file or an email file with the customer ID to the customer computer 20. The customer computer 20 therefore stores the HTML file or email file with the customer ID from past transactions.

The manufacturer computer 30 is installed with a browser 31, which is Web viewing software, and a mailer 32, which is email transmission and reception software. The manufacturer computer 30 is connected to a stamp manufacturing device 33 capable of producing a stamp having a stamp fare based on an image tile transmitted from an external source. As a result, the stamp manufacturing device 33 can produce stamps using data transmitted from the server computer 1 via the manufacturer computer 30.

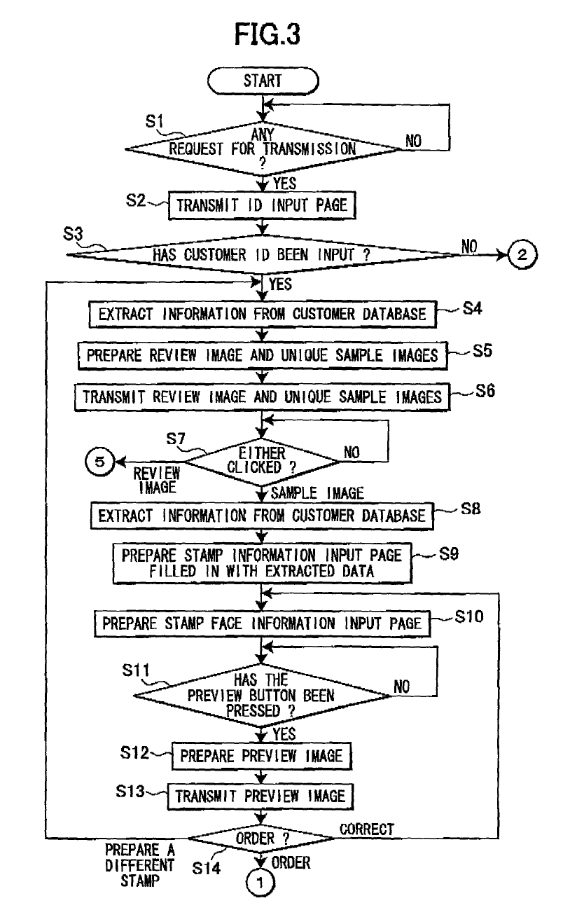

Next, processes according to the present embodiment for selling stamps will be described while referring to FIGS. 3 to 9 FIGS. 3 to 5 are flowcharts representing operations performed at the server. FIGS. 6 to 9 are schematic views showing examples of screens displayed using the browser of the customer computer 20 at various stages of the stamp selling process.

First, in S1 of FIG. 3 the input data analyzing portion 3a of the web management portion 3 repeatedly judges whether a request for transmission of a web page for inputting a customer ID has been received from one of the client devices, such as the customer computer 20. Once such a request for transmission is received, from the customer computer 20 in this example (S1:YES), then the program proceeds to S2. In S2, the database management portion S retrieves an ID input tile used by the browser 21 of the customer computer 20 to display the ID input screen shown in FIG. 6, and the transmission portion 2 transmits the file to the customer computer 20. It should be noted that the ID input screen could be modified to require input of a password in addition to the customer ID. In this case, passwords would also be stored in the customer database 7 in correspondence with each customer ID.

in S3, the input data analyzing portion 3a judges whether or not a customer ID has been input at the customer computer 20 and the customer ID has been transmitted to the server computer 1. If a customer ID has been input and transmitted (S3;YES), the program proceeds to S4. In 54, the database management portion 6 extracts, from the customer database 7, customer's personal information and stamp content information from the past order information that corresponds to the customer ID input in S3. Examples of stamp content information include type of stamp, content of character trains in the stamp face, ink color, and font. Examples of customer's personal information include name, address, telephone number, and email address.

In S5, the review image preparation portion 5b of the image data preparation portion 5 prepares, based on the stamp content information extracted in S4, a review image that reproduces the stamp face of a stamp that the customer with the input customer ID has ordered in the past. Also, the preview image preparation portion 5a of the image data preparation portion 5 prepares a plurality of unique sample images showing different types of stamps. Each sample image includes, on the stamp face, the personal information that was extracted for the customer with the input customer ID.

The unique sample images prepared in S5 can be prepared with a representative ink color and font. For example, black ink could be used as the ink color and Courier New could be used as the font.

In S6, an HTML file with tags for attaching the unique sample images and the review image is retrieved from the Web page database 8. The HTML file is transmitted from the transmission portion 2 to the customer computer 20 along with the unique sample images and the review image prepared in S5. At this time, the unique sample images and the review image, which are displayed on the customer computer 20 based on the HTML file, function as buttons for selecting one of the displayed stamp types. When the customer of the customer computer 20 clicks on one of the attached images using a mouse, then the stamp type shown in the image is selected.

Next, in 57 the input data analyzing portion 3a judges whether or not one of the unique sample images and the review image has been selected by a mouse click at the customer computer 20. If not (S7:NO), then S7 is repeated. If one of the unique sample images is selected (S7:YES), then the program proceeds to se. On the other hand, if the review image is selected, then the input data analyzing portion 3a judges that the customer wishes to order a stamp with the stamp face in the review image, and so the program proceeds to S15 (to be described later) without performing processes for inputting information about the stamp face.

In S8, the database management portion 6 extracts, from the customer database 7, the customer's personal information associated with the customer ID that was input in S3 The customer's personal information could be information about an individual or about a group of individuals, such as a company. when the customer is an individual, then the customer's personal information can include the customer's name, address, postal code, telephone-number, facsimile number, email address, and name, department, and title at the company where employed When the customer is a group of individuals, the customer's personal information can include the name, address, postal code, telephone number, facsimile number and the like of the group.

In S9 the customer's personal information extracted in S8 is transmitted to the output data generation portion 3b of the Web management portion 3. Further, in 39 the output data generation portion 3b prepares a file for displaying the stamp face information input ETML file, which was retrieved from the database management portion 6 from the web page database 8 in S6, with input spaces filled in, in a rewritable manner, with the customer's personal information extracted in SB. In S10, the HTML file prepared in S9 is transmitted to the customer computer 20 by the transmission portion 2.

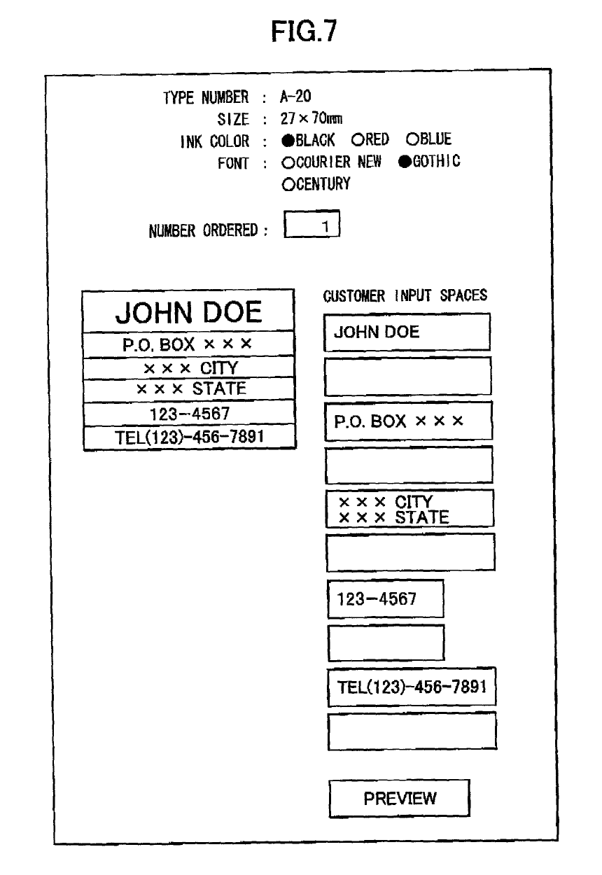

FIG. 7 shows an example of a screen displayed using the browser of the customer computer 20 based on the stamp face information input HTML file, which was extracted from the web page database 8 in S9. An shown in FIG. 7, according to the present embodiment the type number and the size of the selected stamp are already displayed in the screen for inputting stamp face information. In addition, the screen for inputting stamp face information includes dot buttons for selecting ink color, dot buttons for selecting font, a space for inputting the number of stamps desired to be ordered, a stamp face sample, and a preview button. Also blank spaces for inputting characters of the stamp face are provided each below display of an example, These spaces include a name space, two spaces for the address, a postal code space, and a telephone number space.

It should be noted that, although the spaces for inputting characters of the stamp face are indicated in FIG. 7 as being blank, actually the spaces will already be inputted with the customer's name, address, and the like that the customer has input previously. Accordingly, if there is no need to change the text in the spaces, the customer merely clicks the preview button. If there is a need to change the content, the user inputs the appropriate text in the spaces under the examples and then clicks the preview button. When the preview button is clicked, data indicating this is transmitted to the server computer 1 along with the HTML file transmitted to the customer in S10.

In S11, the input data analyzing portion 3a of the web management portion judges whether or not the preview button displayed on the stamp face information input screen has been clicked. If not (S11:NO), then S11 is repeated. If the preview button is clicked (S11:YES), then the program proceeds to S12.

In S12, the input analyzing portion 3a analyzes the data input via the HTML file transmitted to the customer in S10. The preview image preparation portion 5a of the image data preparation portion S prepares, based on the analyzed input data, a preview image showing the stamp face of the stamp to be ordered by the customer this time. The preview image reflects the choices for font, ink color, and content of the stamp face character rows that were input using the screen for inputting stamp face information. Then the program proceeds to S13. In 513, an ETUL file with a tag for appending the preview image prepared in S12 is retrieved from the web page database 8 and transmitted from the transmission portion 2 to the customer computer 20 along with the preview image.

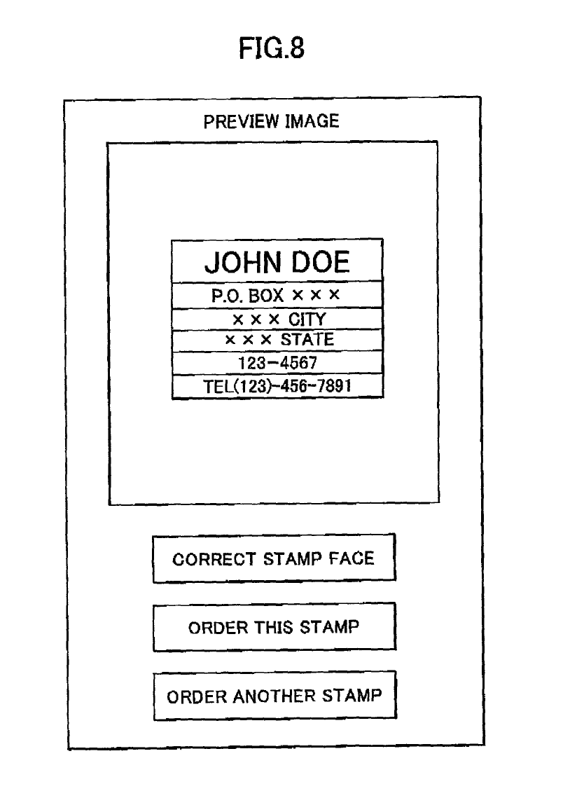

FIG. 8 shows an example of a preview display screen displayed using the browser of the customer computer 20 based on the HTML file for displaying the preview image that was prepared in S12 and that was appended to the HTML file. As shown in FIG. 8, according to the present embodiment, the preview display screen includes a button for correcting the stamp face, a button for ordering the stamp, and a button for ordering another stamp, in addition to the preview image.

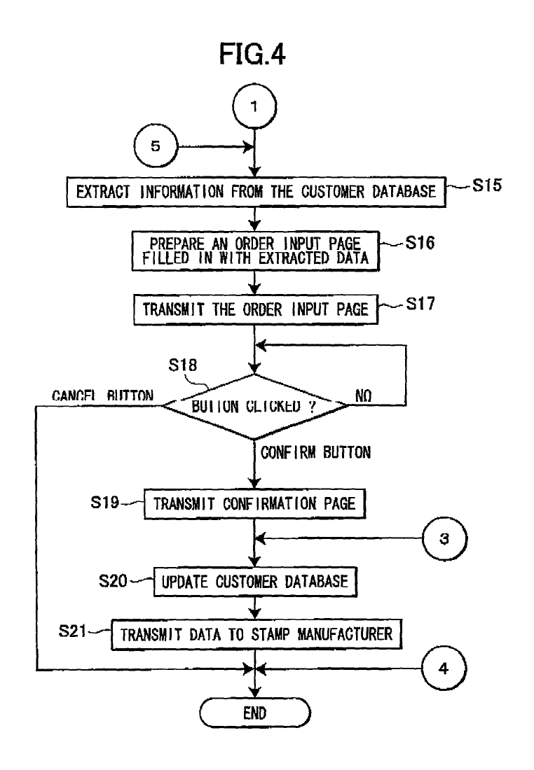

In S14, the input analyzing portion 3a judges whether one of the three buttons displayed on the preview display screen has been selected. When it is judged that the button for ordering a different stamp was selected, then the program returns to S4 and the same procedures are repeated. When it is judged that the button for correcting the stamp face was selected, then the routine returns to S10 and the HTML file for inputting stamp face information is again transmitted to the customer computer 20. If the button for ordering the stamp shown in the preview image is selected, then the program proceeds to S15 of the flowchart in FIG. 4.

In S15, the database management portion 6 extracts, from the customer database, the customer's personal information that corresponds to the customer ID input in S3. When the customer is an individual, then the database management portion 6 extracts the customer's name, address, postal code, and telephone number. When the customer is a company, the database management portion 6 extracts the name, address, postal code, and telephone number of the company.

In S16, the customer's personal information that was extracted in 515 is transmitted to the output data generation portion 3b of the web management portion 3, The database management portion 6 extracts an order information input HTML file from the web page database 8 and transmits it to the output data generation portion 3b. The output data generation portion 3b prepares an HTML file, based on the order information input HTML file, with input spaces for the addressee and for the person that is ordering the stamp filled in, in a rewritable manner, with the customer's personal information that was extracted in S15,

In S17, the HTML file prepared in S16 is transmitted to the customer computer 20 by the transmission portion 2. The browser 21 of the customer computer 20 operates to display an order information input screen based on the file transmitted in S17. The order information input screen includes a preview image showing the stamp face of the ordered stamp, text describing the method of paying for the stamp, the cost of the stamp, a button for confirming the order, and a button for canceling the order. If the customer sees no need to change the addressee, the customer clicks the order confirmation button without changing the content of the space for inputting addressee. On the other hand, if the customer feels the need to chance the addressee, then the customer rewrites the space for inputting the addressee and then presses the order confirmation button. Once the order confirmation button has been clicked, the data indicating this is transmitted to the server computer 1 along with the order information input HTML file that was transmitted in S17.

In S18, the input data analyzing portion 3a judges whether or not one of the two buttons displayed on the order information input screen, that is, the order confirmation button or the order cancellation button, has been clicked on. If nether button has been clicked (S18:NO), then S18 is repeated. If the order cancellation button has been clicked, then this order is cancelled and the top page is resent to the customer computer 20. If the order confirmation button is clicked, then the program proceeds to S19,

In S19 the database management portion 6 retrieves, from the web page database 8, an order confirmed screen HTML file for displaying a screen that indicates that the order of the stamp has been confirmed. The transmission portion 2 transmits the order confirmed screen HTML file to the customer computer 20. Next, in S20 the database management portion 6 rewrites, based on the content of this order, the portion of the customer database associated with the customer ID of the ordering customer.

In S21, the transmission email generation portion 4b of the email management portion 4 generates an email message addressed to the manufacturer computer 30. The email message includes information on the content of the stamp face ordered this time. The generated email message is transmitted to the customer computer 20 by the transmission portion 2 over the Internet 40.

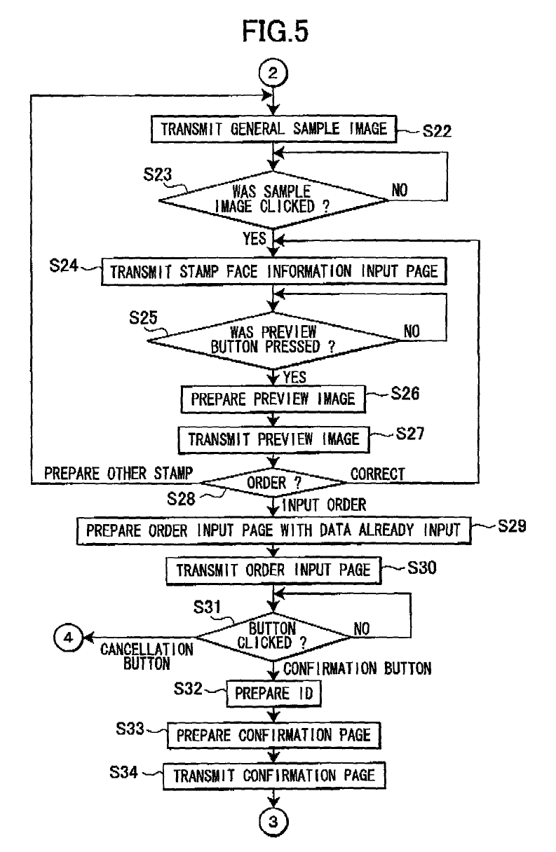

On the other hand, if it is judged in S3 that a customer ID has not been input and transmitted(S3:NO), then the program proceeds to 522 of FIG. 5. In 322, the transmission unit 2 transmits general sample images and an HTML file for displaying the general sample images to the customer computer 20. The general sample images were extracted from the stamp type database 9 for each stamp type. The HTML file was retrieved from the web page database 8 by the database management portion 6 and includes tags for attaching the general sample images.

Next, in S23 the input data analyzing portion 3a judges whether or not the customer of the customer computer 20 clicked on any of the general sample images transmitted in 523. If not (S23:NO), then 523 is repeated If one of the general sample images was clicked on (S23:YES), then the program proceeds to S24.

In S24, the database management portion 6 retrieves the stamp information input HTML file from the web page database 8 and the transmission portion 2 transmits the HTML file to the customer computer 20.

In S25, the input data analyzing portion 3a judges whether the preview button of the stamp face information input screen was pressed. It not (S25.NO), then S25 is repeated. If the preview button was clicked (S25:YES), then the program proceeds to S26.

In S26, the input data analyzing portion 3a analyzes any data that was input to the file transmitted to the customer in S24. The preview image preparation portion 5a of the image data preparation portion S prepares, based on the analyzed input data, a preview image showing the stamp face of the stamp that the customer is considering for order this time. Then the program proceeds to S27, whereupon the transmission portion 2 transmits an ETML file attached with the preview image prepared in S26 to the customer computer 20.

In S28 the input data analyzing portion 3a judges whether one of the three buttons displayed on the preview display screen was clicked. If the button for ordering another stamp was pressed, then the program returns to S22 and repeats processes for ordering a stamp. If the button for correcting the stamp face was clicked, then the program returns to S24, whereupon the HTML file is again transmitted to the customer computer 20 along with the data that was already input. If the order button was clicked, then the program proceeds to S29.

In S29, the personal information that was input using the stamp face information input screen transmitted in S24 is transmitted to the output data generation portion 3b of the web management portion 3 Further, the output data generation portion 3b prepares a file for displaying the stamp face information input HTML file, which was retrieved by the database management portion 6 from the web page database 8, with the input spaces for the name of the orderer and addressee of the stamp filled in, in a rewritable manner, with the personal information input into the print face input screen during preparation of the preview image.

In S30 the HTML file prepared in S29 is transmitted to the customer computer 20 by the transmission portion 2. In S31, the input data analyzing portion 3a judges whether or not either of the buttons displayed on the order information input screen, that is, the order confirmation button or the order cancellation button, was clicked on using the mouse of the customer computer 20. If not (S31:NO), then S31 is repeated. If the order cancellation button was pressed, then this purchase is cancelled and the top page is transmitted to the customer computer 20. If the order confirmation button is pressed, then the program proceeds to S32.

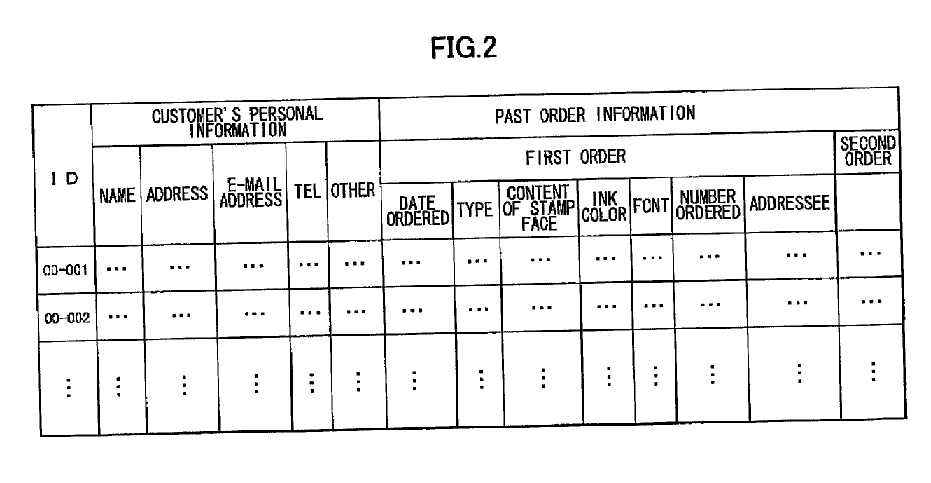

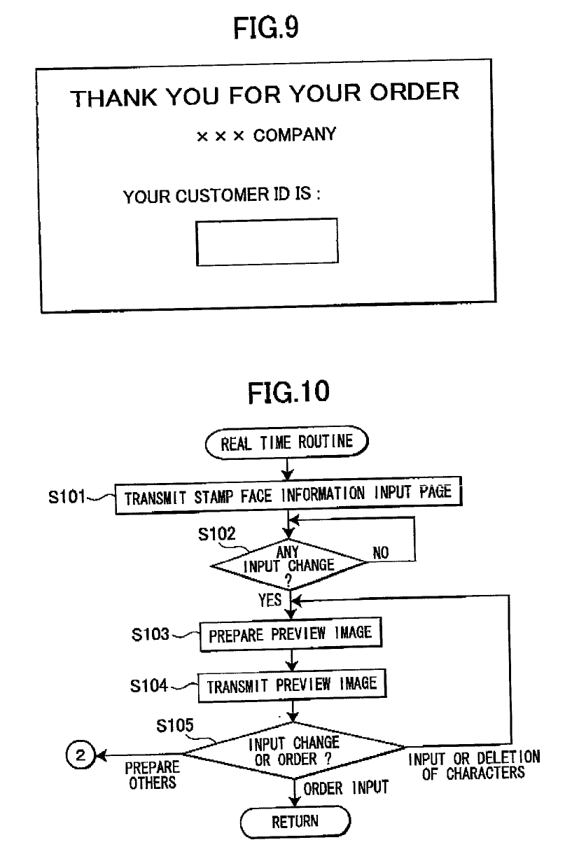

In S32, the database management portion 6 prepares a new customer ID for the present orderer, that is, the person's name that was input into the orderer input space of the order information input screen. In S33, the database management portion 6 retrieves, from the web page database 8, the order confirmed HTML file for confirming that the order for the stamp has been received. The output data generation portion 3b rewrites the order confirmed HTML file to include the customer ID that was prepared in S32. In S34, the transmission portion 2 transmits the rewritten order confirmed HTML file to the customer computer 20. As shown in FIG. 9, the browser 21 operates to display the order confirmed HTML file to include the newly issued customer ID. Afterward, the customer information and the order information of this first order are written, along with the customer ID, into the customer database 7 shown in FIG. 2.

The customer can purchase the stamp after confirming, using the browser 21 of the customer computer 20, the preview image that shows the stamp face of the stamp the customer is about to purchase. Accordingly, there is no danger of the customer receiving delivery of a stamp with a stamp face that differs greatly from the image that the customer had of the stamp face. The customer can order stamps over the Internet with a feeling of security. This greatly increases convenience of purchasing stamps over the Internet.

The preview image is prepared and transmitted to the customer computer 20 only after the customer clicks on the preview button to request transmission of a preview image. Therefore, the data for displaying the preview image is transmitted from the server computer 1 to the customer computer 20 only once after the stamp face information is input. Accordingly, not much time is required to transmit the data for the preview image even if the server computer 1 and the customer computer 20 communicate at a low transmission rate. Therefore, the customer will not feel frustrated waiting for the preview image to appear on the screen of the customer computer 20.

When a customer imputs a customer ID during the process of ordering a stamp, the browser 21 operates to display a preview image, such as a unique sample image, that indicates the stamp face with personal information of the customer having the input customer ID. This greatly reduces the labor required of the customer to input the stamp face using the keyboard

When a customer with no customer ID orders a stamp, the database management portion 5 issues a customer ID and notifies the customer of this customer ID. This facilitates the stamp ordering process for the customer the next time the customer orders a stamp.

When the customer computer 20 is used to purchase a stamp from the server computer 1, the server computer 1 transmits, to the customer computer 20, a data file called a cookie that functions as an identifier for the customer computer 20. The customer computer 20 stores the cookie. If the customer computer 20 uses the cookie instead of a customer ID as an identifier, the customer need not go to the trouble of inputting the customer ID.

The browser 21 can operate to display a reproduction of a stamp ordered in the past, in the form of a review image of the stamp face, based on information about a stamp that was ordered in the past. Therefore, customer can refer to the layout of a stamp purchased in the past when designating the content of a new product to purchase. Further, because the browser 21 operates to display a review image and a unique sample image of the stamp face, the customer can easily determine the content of the product to be newly purchased. It should be noted that a stamp type and the like of a stamp desired to be purchased can be previously input. With this configuration, the browser 21 can operate to display a review image and a preview image based on this previously input information.

When a customer ID is input, the information extracted from the customer information stored in the customer database 7 is used as information indicating a review image, information indicating a preview image, and personal information about the addressee and the orderer inputted in the order information input screen. On the other hand, when no customer ID is input, the personal information input into the print face input screen is used as the personal information about the addressee and the orderer inputted in the order information input screen. Therefore, there is no need for the customer to input redundant information and the amount of trouble that the customer needs to go through to input characters using the keyboard is greatly reduced.

It should be noted that mutually linking and using the data input from the keyboard and data stored in the customer database 7 can be performed in other situations as well For example, when the customer ID is input then the personal information, for either of the orderer and the addressee, that was input into the order information input screen can be used as the personal information input into the stamp face information input screen. Or when no customer ID is input, the personal information for the orderer that was input into the order information input screen can be used as the personal information that is input into the stamp face information input screen or the personal information of the addressee that is input into the order information input screen.

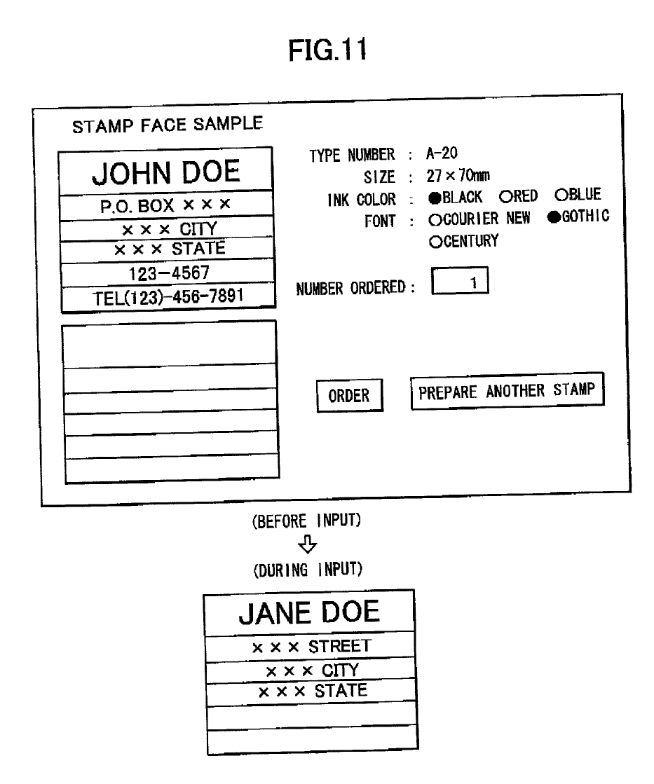

Next, a modification of the embodiment wherein the preview image is prepared in real time will be explained based on FIGS. 10 and 11 FIG. 10 is a flowchart representing processes performed by the server for selling stamps according to the modification. FIG. 11 is a schematic view showing a screen displayed by operation of the browser 21 of the customer computer 20 during the stage of stamp purchase for inputting information about the stamp face. It should be noted that the program according to the modification of the embodiment is the same as the embodiment, except for the portion that corresponds to S10 to S14 of FIG. 3 and S24 to S28 of FIG. 5. Therefore, FIG. 10 only shows this portion and explanation of other portions will be omitted. Although the flowchart of FIG. 10 only shows processes performed when the customer ID is not input in S3, that is, in the section that corresponds to S24 to S28 of FIG. 5, substantially the same processes are performed when a customer ID is input.

First, in S101 the database management portion 6 retrieves, from the web page database 8, an HTML file for displaying a print face information input screen shown in FIG. 11. The transmission portion 2 transmits the HTML file to the customer computer 20. According to the modification, a plug in capable of real time processing is incorporated into the browser 21 of the customer computer 20 in order to displayed preview images in real time.

The screen displayed by operation of the browser using the HTML file enables the customer to input characters of the stamp face directly into the layout of the stamp type selected in S23. Also, the screen differs from that shown in FIG. 7 by including an order button and a prepare another stamp button, instead of the preview button of FIG. 7.

Next, in S103, the input data analyzing portion 3a of the web management portion 3 judges whether or not there has been a change in the content of the stamp face information input screen other than the number of stamps to be ordered. That is, the input data analyzing portion 3a judges whether or not characters have been input or deleted, or whether a different ink color or font has been designated. If there has been no change in the input content (S102:NO), then S102 is repeated. If there has been a change in the input content (S102:YES), then the program proceeds to S103,

S103 the input data analyzing portion 3a analyzes data input into the HTML file for the stamp face information input screen. Based on the analyzed input data, the preview image preparation portion 5a of the image data preparation portion 5 prepares a preview image including the stamp face of the stamp that the customer is considering to order this time. The preview image reflects the font, ink color, and content of character trains input using the print face information input screen. In S104 the transmission portion 2 transmits the preview image prepared in S103 to the customer computer 20. The browser 21 of the customer computer 20 operates to display a preview image that shows the stamp face changing in real time response to changes in input content There is no need for the customer to click on a preview button.

In S105 the input data analyzing portion 3a judges whether or not there has been a change in the content of the stamp face information input screen other than the number of stamps to be ordered and whether or not either of the two buttons displayed on the stamp face information input screen has been clicked on. As a result, when it is judged that input content has been changed, then the routine returns to S103, so that a preview image is again prepared in real time in S103 and transmitted to the customer computer 20 in S104.

If the button for ordering another stamp is clicked on, then the routine returns to S22 of FIG. 4 and the successive processes are repeated. If the button for ordering the stamp is clicked on, then the routine proceeds to S29 of FIG. 5.

According to the modification, the customer merely needs to input changes in content of input characters and the browser 21 of the customer computer 20 operates to display a preview image that reflects the changes in real time. There is no need for the customer to click with a mouse or perform some other operation to see how the changes will look. The purchaser can automatically confirm the preview image that corresponds to input characters This aspect of the present invention is particularly effective when the server and the client devices are connected by a connection with a high transmission speed.

Although FIG. 11 shows the spaces for input stamp face content as being blank spaces, the system can be further modified so that when a customer ID is input in S3, a stamp face input HTML file for displaying a preview image with spaces filled in from the start with the customer's name, address, and the like is transmitted to the customer computer 20.

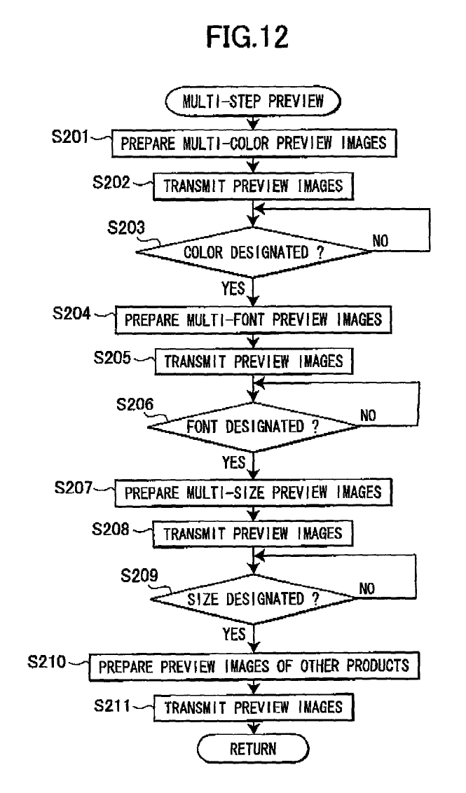

Another modification of the embodiment will be explained with reference to FIG. 12 In this modification, plural sets of preview images are displayed for showing different ink colors, different fonts, and different stamp sizes. FIG. 12 is a flowchart representing processes performed by the server according to the method of selling stamps according to the modification. It should be noted that the processes according to the present modification differ from those of the embodiment at S12 and S13 of FIG. 3 and S26 and S27 of FIG. 5 and that the stamp face information input screen is displayed without the buttons for selecting font and ink color. FIG. 12 shows processes relating only to these differing portions. Explanation of common portions will be omitted. Also, processes according to the present modification are substantially the same.

In S210 the input data analyzing portion 3a analyzes the stamp face character train content data input in the HTML file that was transmitted to the customer in S10 or S24. Based on the analyzed input data, the preview image preparation portion 5a of the image data management portion 5 prepares a first set of preview images showing the stamp face of the stamp that the customer ordered this time. Each preview image in the set shows characters input into the print face information input screen in a representative font, such as Courier New font. However, each preview image shows the characters in a different one the ink colors that the stamp can be produced with. In the present modification, stamps can be produced in three different colors of black, red, and blue so three different preview images are prepared, one for each color.

In S202 the database management portion 6 retrieves, from the web page database 8, an HTML file with tags for attaching the preview images prepared in S201. The transmission portion 2 transmits the ITML file along with the three preview images to the customer computer 20. The browser 21 of the customer computer 20 operates to display the preview images showing the same stamp face with the same character trains in the same font, but with the character trains displayed in a different color in each preview image.

Next, in S203 the input data analyzing portion 3a repeatedly judges whether one of the different-color preview images has been clicked. If none of the preview images was selected the program repeats S203. If one of the preview images was clicked to designate an ink color, then the program proceeds to S204.

In S204 the preview image preparation portion 5a of the image data preparation portion 5 prepares a plurality of preview images that all reflect the stamp face character train content input using the print face information input screen and the ink color designated by a mouse click in S203. However, each preview image shows the character trains in a different font that the stamps can be manufactured in, that is, the three different fonts of Courier New, Gothic, and Century of the embodiment.

In S205 the web management portion 5 retrieves, from the web page database 8, an HTML file with tags for attaching the preview images prepared in S204. The transmission portion 2 transmits the HTML file along with the preview images that show the different fonts. The browser 21 of the computer 20 operates to display the preview images with the same character trains in the same ink color, but with different fonts.

In S206 the input data analyzing portion 3a repeatedly judges whether or not one of the different-fonted preview images displayed on the multi-font preview display screen was clicked on at the customer computer 20. If none of the preview images were mouse clicked, then S206 is repeated. If one of the preview images is clicked, then this means that the customer has designated one of the character fonts so the program proceeds to S207.

In S207 the preview image preparation portion 5a of the image data preparation portion 5 prepares a plurality of preview images that all reflect the stamp face character train content that was input using the print face information input screen, the color designated by a mouse click in S203, and the font designated by a mouse click in S206. However, each preview image shows the stamp face in a different one of the sizes in which the stamp face can be produced. The preview images prepared in processes before S207 all show the stamp face size in the layout selected in S7 or S23. However, in S207 preview images are prepared with the same ratio between vertical and horizontal dimensions, but magnified or reduced, to show all the stamp face sizes that stamps can be produced in.

In S208 the database management portion 6 retrieves, from the web database 8, an HTML file including tags for attaching the preview images prepared in S207. The transmission portion 2 transmits the HTML filo along with the different-sized preview images to the computer 20. The browser 21 of the computer 20 operates to display the preview images with the same character trains on the stamp face, in the same color ink and the same font, but in different sizes. At this time, the browser 21 displays check boxes and an order button next to each preview image. The check boxes are for the customer to indicate whether he or she wishes to purchase one or more stamps

S209 the input data analyzing portion 3a repeatedly judges whether the order button displayed in the multi-size preview display screen transmitted in S208 was mouse clicked, If the order button was not mouse clicked, then S209 is repeated. If the order button was mouse clicked, then the input data analyzing portion 3a judges which check box was checked and then the program proceeds to S210.

In S210 the preview image preparation portion 5a of the image data preparation portion 5 uses the information input up to now to prepare one or more preview images of one or more other products that can be ordered through the computer 1. The other products are those other than a stamp, such as a business card or a tag.

In S211 the database management portion 6 retrieves, from the web page database 8, an HTML file that includes tags for attaching the preview images prepared in S210. The transmission portion 2 transmits the retrieved HTML file along with the preview images of other products to the customer computer 20. The browser 21 of the computer 20 operates to display the preview images of the products other than stamps. It should be noted that the system enables the customer to select the ink color, layout, font, and the like of these other products as well.

According to this modification, preview images can be displayed showing a stamp face in different ink colors, fonts, and sizes. Therefore, the customer can more reliably confirm the status of the stamp face before purchasing a stamp. The customer will be able to purchase stamps with greater peace of mind. According to the present modification, preview image of products other than stamps, such as business cards, can be displayed. This urges customers to buy different products

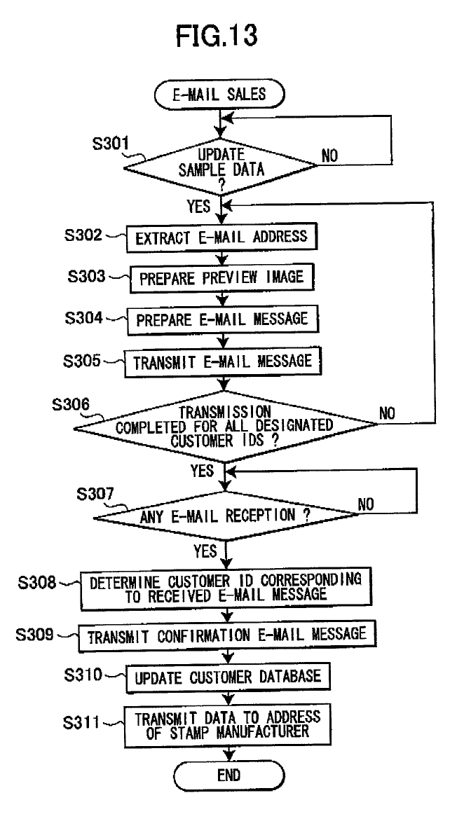

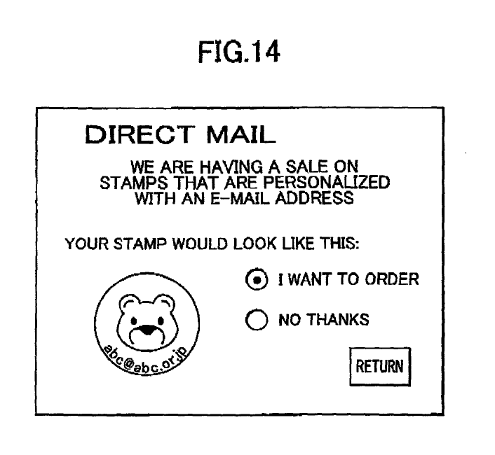

Next, another modification of the embodiment will be described while referring to FIGS. 73 and 14. In this modification, the system of the embodiment is modified for direct mail sales of stamps. FIG. 13 is a flowchart representing operations performed by the computer 1 according to the modification. FIG. 14 is a schematic view showing a screen displayed by operation of the mailer 22 in the customer computer 20. It should be noted that the direct mail sales are performed according to the present modification with respect to customers that have been issued a customer ID.

In S301 the database management portion 6 judges whether the stamp type database 9 has added any new stamp designs from the stamp seller. If there have been no additions to the stamp type database 9 (S301:NO), then S301 is repeated. If it is judged that there has been an addition to the stamp type database 9 (S301:YES), then the program proceeds to S302.

In S302 the email address of a customer to which the direct email message is to be sent and information required for the added stamp design, such as name and address of the customer, is extracted from the customer database 7. Direct email messages need not be sent to all customers registered in the customer database 7, but can instead be sent only to customers that match predetermined conditions, such as address, age, and the number of items purchased in the past.

In S303 the preview image preparation portion 5a uses the information extracted from the database to prepare preview images for the added stamp design. The stamp can include at least one of the customer's email address, name, and telephone number.

In S304 the transmission email generation portion 4b of the email management portion 4 prepares an email message directed to the email address associated with each customer ID. The email messages include the preview image prepared in S303. In S305, the transmission portion 2 transmits the prepared email messages to the email addresses extracted in S302.

The mailer 22 of a customer that received the email messages displays the email message as shown in FIG. 14 to include a preview image of the new stamp design, dot buttons for ordering the new stamp or not, and a return button. Accordingly, customers who desire to purchase the new stamp select the dot button labeled “I WANT TO ORDER” and then clicking on the return button to transmit an email message to the computer 1 that indicates the customer's desire to purchase the new design.

In S306 it is determined whether email messages have been transmitted to all customers with a selected customer ID. If not (S306:NO), then the program returns to S302 and repeats the same processes. If all email messages have been sent (S306:YES), then the program proceeds to S307.

In S307 the received email analyzing portion 4a of the email management portion 4 judges whether an email message has been received based on POP If there are no received email messages (S307:NO), then the program returns to S307. If an email message is received (S307:YES), then the program proceeds to S308.

In S308 the received email analyzing portion 4a uses the email address of the received email message, while referring to the customer database 7, to designate a customer ID that corresponds to the received email message.

Next in S309 the transmission email generation portion 4b uses the email file stored in the web page database 8 to prepare an email message for confirming the order. The prepared email message is transmitted to the email address that corresponds to the customer ID designated in S308.

Next in S310 the database management portion 6 rewrites the portion of the customer database relating to the customer ID of the customer that ordered the product, based on the content of the order placed for the direct email sale.

In S311 the transmission email generation portion 4b of the email management portion 4 generates an email message addressed to the manufacturer computer 30. The email message includes print face content information relating to the order placed this time. The transmission portion 2 transmits the prepared email message over the Internet 40 to the manufacturer computer 30, whereupon it is displayed by operation of the mailer 32. It should be noted that an HTML file for displaying the stamp face information of the present order can be transmitted to the manufacturer computer 30 instead of sending an email message.

During an email sale according to this modification, the server prepares a preview image showing a stamp face with content that the server feels is suitable and transmits it to the customer in an email message, without the customer having to select ink color or character trains of the print face. Customers that desire to change the preview image in the transmitted email need to access the web page of the server computer 1 using the web to change the content.

According to this modification, when a preview image showing a newly designed stamp is transmitted as an email message to customers stored in the customer database 7, the customer can easily order a stamp by pressing the displayed return button, without the need to view a catalog, access the web site for stamp sales, or input data into an order form. This stimulates the desire of customers to purchase more, which results in new demand for stamps.

While the invention has been described in detail with reference to specific embodiments thereof, it would be apparent to those skilled in the art that various changes and modifications may be made therein without departing from the spirit of the invention, the scope of which is defined by the attached claims. For example, the present invention can be applied to a variety of unique information indicating products other than stamps or business cards.

What is claimed is:

1. A method for selling, over a transmission network, unique information indicating products that indicate unique information, the method comprising:
receiving, at a server, unique information supplied from a client device across the transmission network to the server;
preparing, based on unique information, a preview image of a unique information indicating product that indicates the unique information;
transmitting the prepared preview image to the client device; and
displaying the preview image using a browser of the client device.

2. A method as claimed in claim 1, wherein the steps of preparing and displaying are performed in real time response to character input performed at the client device for the unique information.

3. A method as claimed in claim 1, wherein the steps of preparing and displaying are performed in response to a preview reception request sent from the client device to the server.

4. A method as claimed in claim 1, wherein the step of displaying includes displaying, using the browser of the client device, a plurality of preview images corresponding to different colors selectable for the unique information indicating product.

5. A method as claimed in claim 1, wherein the step of displaying includes displaying, using the browser of the client device, a plurality of preview images corresponding to different text fonts selectable for the unique information indicating product.

6. A method as claimed in claim 1, wherein the step of displaying includes displaying, using the browser of the client device, a plurality of preview images corresponding to different sizes selectable for the unique information indicating product.

7. A method as claimed in claim 1, wherein the step of displaying includes displaying, using the browser of the client device, a plurality of preview images corresponding to different types selectable for the unique information indicating product.

8. A method as claimed in claim 1, wherein:
the step of receiving the unique information includes receiving a customer identifier;
the step of preparing the preview image includes extracting, from a customer database that stores customer identifiers in correspondence with customer information, unique information associated with the customer identifier and preparing the preview image to indicate the extracted unique information on the unique information indicating product; and
the step of displaying includes displaying the extracted unique information in the preview image of the unique information display product.

9. A method as claimed in claim 8, wherein:
the step of preparing includes preparing a customer identifier when the server receives unique information to be displayed on the unique information indicating product, but does not receive a customer identifier; and
the step of transmitting the prepared preview image to the client device includes transmitting the prepared customer identifier.

10. A method for selling, over a transmission network, unique information indicating products that indicate unique information, the method comprising:
transmitting a customer identifier from a client device over the transmission network to a server;
receiving the customer identifier at the server;
extracting, from a customer database that stores customer identifiers in correspondence with customer information, past order information associated with the customer identifier;
preparing, based on the past order information extracted from the database, a review image of a unique information indicating product ordered in the past;
transmitting the prepared review image to the client device; and
displaying the review image using a browser of the client device.

11. A method as claimed in claim 10, wherein:
the step of transmitting the prepared review image to the client device includes transmitting, along with the review image, at least one of a sample image of a unique information indicating product and a preview image of a unique information indicating product that indicates the unique information extracted from the customer database; and
the step of displaying includes displaying, along with the review image, the at least one of the sample image and the preview image.

12. A method for selling, over a transmission network, unique information indicating products that indicate unique information, the method comprising:
using at least one of order information for a unique information indicating product and unique information to be indicated on the unique information indicating product as corresponding information in another one of the at least one of the order information and the unique information.

13. A method as claimed in claim 12, wherein the step of using includes using a portion of the corresponding information in the order information as corresponding information for another portion of at least one of the order information and the unique information.

14. A method for selling, over a transmission network, unique information indicating products that indicate unique information, the method comprising:
extracting, based on a customer identifier, unique information from a customer database that stores customer identifiers in correspondence with customer information;
preparing a preview image of a unique information indicating product that indicates the extracted unique information; and
transmitting the prepared preview image to an email address associated with the customer identifier.

15. A system for selling unique information indicating products that indicate unique information, the system comprising:
a client device and a server connected via a transmission network, wherein:
the client device supplies unique information to the server across the transmission network;
the server receives the unique information supplied from the client device, prepares, based on the unique information supplied from the client device, a preview image of a unique information indicating product that indicates the unique information, and transmits the prepared preview image to the client device; and
the client device includes a browser that displays the preview image from the server.

16. A system as claimed in claim 15, wherein:
the server prepares the preview image of the unique information indicating product, and transmits the preview image to the client device, in real time response to character input performed at the client device for the unique information; and
the client device displays the preview image using the browser in real time.

17. A system as claimed in claim 15, wherein:
the client device transmits a request to receive a preview to the server; and
the server prepares the preview image of the unique information indicating product, and transmits the preview image to the client device, in response to the request from the client device.

18. As system as claimed in claim 15, wherein:
the client device supplies a customer identifier with the unique information to the server across the transmission network;
the server extracts unique information associated with the customer identifier from a database that stores customer identifiers in correspondence with customer information; and
the server prepares and transmits the preview image of the unique information indicating product indicating the unique information extracted from the customer database.

19. A system as claimed in claim 18, wherein when the server receives, from the client device, unique information to he indicated on the unique information indicating product, but does not receive a customer identifier, the server prepares a customer identifier and a preview image of the unique information product indicating the unique information and transmits the preview image and the customer identifier to the client device.

20. A system for selling unique information indicating products that indicate unique information, the system comprising:
a client device and a server connected via a transmission network, wherein:
the client device supplies the customer identifier to the server across the transmission network; and
the server receives the customer identifier supplied from the client device and extracts, from a customer database that stores customer identifiers in correspondence with customer information, information about past orders associated with the customer identifier;
the server prepares, based on the information about past orders extracted from the database, a review image of a unique information indicating product ordered by a customer in the past;
the server transmits the review image to the server; and
the client device includes a browser that displays the review image.

21. A system as claimed in claim 20, wherein:
the server transmits to the client device, along with the prepared review image, at least one of a sample image of a unique information indicating product and a preview image of a unique information indicating unique information extracted from the customer database; and
the client device uses the browser to display the at least one of the sample image and the preview image along with the review image.

22. A system for selling unique information indicating products that indicate unique information, comprising:
a client device and a server connected via a transmission network, wherein:
one of order information for a unique information indicating product and unique information to be indicated on the unique information indicating product is used as corresponding information in the other of the at least one of order information and unique information.

23. A system as claimed in claim 22, wherein a portion of the corresponding information in the order information is used as corresponding information for another portion of at least one of the order information and the unique information.

24. A system for selling unique information indicating products that indicate unique information, comprising:
a client device and a server connected via a transmission network, wherein:
the server extracts, based on a customer identifier, unique information from a customer database that stores customer identifiers in correspondence with customer information, prepares a preview image of a unique information indicating product that indicates the extracted unique information, and transmits the prepared preview image to an email address associated with the customer identifier.

25. A server for selling, over a transmission network, unique information indicating products that indicate unique information, the server comprising:
a preview image preparation unit that prepares, based on unique information supplied over the transmission network from a client device, a preview image of a unique information indicating product that indicates the unique information; and
a transmission unit that transmits the prepared preview image to the client device.

26. A server as claimed in claim 25, wherein the preview image preparation unit prepares the preview image of the unique information indicating product, and the transmission unit transmits the preview image, in real time response to character input performed at the client device for the unique information.

27. A server as claimed in claim 25, wherein the preview image preparation unit prepares the preview image of the unique information indicating product, and the transmission unit transmits the preview image, in response to a preview reception request sent from the client device to the server.

28. A server as claimed in claim 25, further comprising:
a memory storing a customer database with customer identifiers in correspondence with customer information; and
a unique information extracting unit that extracts, from the customer database, unique information to be indicated on the unique information indicating product, based on a customer identifier supplied from a client device over the transmission network, the preview image preparation unit preparing the preview image of the unique information indicating product to indicate the unique information extracted from the customer database.

29. A server as claimed in claim 28, further comprising:
a customer identification preparation unit that prepares a customer identifier when unique information indicated on the unique information indicating product is supplied over the transmission network but a customer identifier is not supplied, the preview image preparation unit prepares the preview image of the unique information indicating product to indicate unique information when unique information to be indicated on the unique information indicating product is supplied over the transmission network from a client device, the transmission unit transmitting the preview image and the customer identifier to the client device.

30. A server for selling unique information indicating products that indicate unique information, comprising:
a memory storing a customer database with customer identifiers in correspondence with customer information;
an order information extracting unit that extracts, from the customer database, information about past orders associated a customer identifier supplied from a client device over the transmission network;
a review image preparation unit that prepares a review image of a unique information indicating product based on the past order information extracted from the customer database; and
a transmission unit transmitting the prepared review image to the client device.

31. A server as claimed in claim 30, wherein the transmission unit transmits, to the client device, the review image and at least one of a sample image of a unique information indicating product and a preview image of a unique information indicating product indicating unique information extracted from the customer database.

32. A server for selling, over a transmission network, unique information indicating products that indicate unique information, the server comprising:
using means that uses one of order information for a unique information indicating product and unique information to be indicated on the unique information indicating product as corresponding information in the other of the at least one of order information and unique information.

33. A server as claimed in claim 32, wherein the using means uses a portion of the corresponding information in the order information as corresponding information for another portion of at least one of the order information and the unique information.

34. A server for selling unique information indicating products that indicate unique information, comprising:
a memory storing a customer database with customer identifiers in correspondence with customer information;
a preview image preparation unit that prepares a preview image of a unique information indicating product that indicates unique information extracted from the customer database; and
a transmission unit that transmits the prepared preview image to an email address corresponding to one of the customer identifiers.
